(19) United States
(12) Patent Application Publication
(10) Pub. No.: US 2015/0118638 A1
(43) Pub. Date: Apr. 30, 2015

(54) Intraoral Imaging Apparatus

(71) Applicant: Trispera Dental, Inc., Calgary (CA)

(72) Inventor: George Cowburn, Calgary (CA)

(21) Appl. No.: 14/389,994

(22) PCT Filed: Apr. 4, 2013
(86) PCT No.: PCT/CA2013/050273

§ 371 Date: Oct. 1, 2014

Related U.S. Application Data
(60) Provisional application No. 61/620,944, filed on Apr. 5, 2012.

(51) Int. Cl. A61C 9/00; A61C 1/08

(52) U.S. Cl. CPC A61C 9/0073; A61C 9/0006; A61C 9/0093; A61C 1/088
USPC 433/29

(57) ABSTRACT

An intraoral apparatus and method of using the same. The apparatus includes a tray for positioning within an oral cavity of an individual to receive a dental arch of the individual. Data acquisition elements coupled to the tray are for acquiring data usable for generating images of intraoral features including the dental arch, a palate, a facial sulcus, and a lingual sulcus of the individual. The images are combinable for determining a sulcus depth of the individual.

### FIELD

The present disclosure relates generally to intra-oral imaging.

### BACKGROUND

When making dentures for a patient, models are typically prepared from the patient's dental arches. Dental arches are generally modeled using an impression compound in an impression tray.

U.S. Pat. No. 6,386,867 to Durbin et al. discloses intra-oral methods and apparatus for optically imaging a dental structure and creating representative 3D models from the images. Durbin discloses an intraoral scanner with a mouthpiece wherein one or more image apertures are mounted on a shuttle. The shuttle moves along a lateral rail or track that is mounted on the mouthpiece to image frontal and posterior views of the patient's teeth. The scanner may include nozzles for directing pressurized air at the dental structure being imaged, exemplified and claimed as a tooth-gum interface, to create a dry field.

U.S. Pat. No. 6,821,116 to Severance discloses methods and devices for scanning an oral environment. Severance teaches a device comprising a mouthpiece, a scanning device disposed within the mouthpiece for capturing one or more images of the oral environment, and an electronic storage device for storing each image of the oral environment. The scanning device is fit into or formed into the mouthpiece and moves along a track and scans back and forth in an arc around the length of the mouthpiece and across the buccal side of the patient's teeth to capture an image of the teeth and gums. Alternatively, the camera may be stable within the mouthpiece while mirrors move along the track to help capture images of the teeth and gums.

U.S. publication 2005/0202363 to Osterwalder discloses a dental imaging and treatment system. Osterwalder discloses a device for imaging the internal structure of teeth using visible light projected through the teeth to sensors sensitive to the visible light. The light may also be used for the activation and resulting curing of liquid and semi-liquid materials used in commercial dental applications. Example materials are for forming dental impressions, teeth whitening, filling cavities, and similar tasks. Materials used for such purposes are cured or hardened to a desired level when subjected to irradiation with photons of proper predetermined wavelength.

U.S. publication 2009/0298017 to Boerjes et al. discloses systems and methods for dental applications of digital three-dimensional representations of dentition. Boerjes teaches acquiring a three-dimensional representation of one or more intraoral structures of a dental patient using an intraoral scanner. An exemplified scanner, or scanning device, includes any camera or camera system suitable for capturing images from which a three-dimensional point cloud may be recovered, exemplified by a multi-aperture system disclosed in U.S. publication 2004/0155975 to Hart et al. The scanner is generally a handheld, freely positionable probe shaped and sized for dental scanning.

### SUMMARY

It is an object of the present disclosure to obviate or mitigate at least one disadvantage of previous devices and methods of acquiring data for modeling intraoral features.

In a first aspect, the present disclosure provides an intraoral apparatus and method of using the same. The apparatus includes a tray for positioning within an oral cavity of an individual to receive a dental arch of the individual. Data acquisition elements coupled to the tray are for acquiring data usable for generating images of intraoral features including the dental arch, a palate, a facial sulcus, and a lingual sulcus of the individual. The images are combinable for determining a sulcus depth of the individual

In a further aspect, the present disclosure provides an intraoral apparatus including a tray for positioning within an oral cavity to receive a dental arch, first data acquisition elements coupled to an arch-facing surface of the tray, the first data acquisition elements for acquiring first data usable for generating first images comprising a portion of the dental arch, and second data acquisition elements coupled to an edge surface of a sidewall of the tray, the second data acquisition elements for acquiring second data usable for generating second images comprising a portion of a facial sulcus. The first images and the second images are combinable for determining a facial sulcus depth.

In an embodiment, a portion of the arch-facing surface is contoured for conforming to the shape of a palate, a portion of the first images comprise a portion of the palate, and the portion of the first images is combinable for determining the location of a vibrating line.

In an embodiment, the intraoral apparatus includes third data acquisition elements coupled to an edge surface of an endwall of the tray, the endwall in an opposed and spaced-apart relationship with the sidewall, the third data acquisition elements for acquiring third data usable for generating third images comprising a portion of a lingual sulcus. The first images and the third images are combinable for determining a lingual sulcus depth.

In an embodiment, the intraoral apparatus includes third data acquisition elements coupled to an edge surface of an endwall of the tray, the endwall in an opposed and spaced-apart relationship with the sidewall, the third data acquisition elements for acquiring third data usable for generating third images comprising a portion of a lingual sulcus. The first images and the third images are combinable for determining a lingual sulcus depth. The intraoral apparatus includes fourth data acquisition elements coupled to a lingual flange extending from the endwall edge surface, the fourth data acquisition elements for acquiring fourth data usable for generating fourth images comprising a portion of lingual mobile gingival tissue.

In an embodiment, the tray includes a spacer for positioning the tray within the oral cavity at a distance from the dental arch.

In an embodiment, the intraoral apparatus includes headgear couplable to the tray for positioning the tray within the oral cavity.

In an embodiment, the intraoral apparatus includes a handle coupled to the tray for positioning the tray within the oral cavity.

In an embodiment, the intraoral apparatus includes a light source coupled to the tray for illuminating the oral cavity.

In an embodiment, the intraoral apparatus includes a projector coupled to the tray for projecting an orientation point onto a surface of the oral cavity.

In an embodiment, the intraoral apparatus includes fourth data acquisition elements coupled to a facial flange extending from the sidewall edge surface, the fourth data acquisition elements for acquiring fourth data usable for generating fourth images comprising a portion of facial mobile gingival tissue

In an embodiment, the first data acquisition elements and the second data acquisition elements are synchronized for acquiring the first data simultaneously with the second data.

In an embodiment, the first data acquisition elements and the second data acquisition elements comprise a heat-resistant coating for protection from heat during cleaning.

In an embodiment, the tray comprises a portion made from a deformable material.

In an embodiment, the tray comprises a portion made from made from one or more pairs of rigid segments, each pair of rigid segments joined by an articulatable coupling.

In an embodiment, the first data acquisition elements and the second data acquisition elements are removable from the intraoral apparatus.

In an embodiment, the first data acquisition elements and the second data acquisition elements are in communication with an image generating apparatus.

In an embodiment, the first data acquisition elements and the second data acquisition elements are in communication with an image generating apparatus, and the image generating apparatus is a computer or a printer.

In an embodiment, the first data acquisition elements include a first memory for storing the first data and the second data acquisition elements include a second memory for storing the second data.

In an embodiment, the tray includes a spacer for positioning the tray within the oral cavity at a distance from the sulcus.

In an embodiment, the tray includes a spacer for positioning the tray within the oral cavity at a distance from the palate.

In an embodiment, the tray includes a spacer for positioning the tray within the oral cavity at a distance from the arch and the distance is equal to or less than the focal length of the first data acquisition elements.

In an embodiment, the tray includes a spacer for positioning the tray within the oral cavity at a distance from the sulcus, and the distance is equal to or less than the focal length of the second data acquisition elements.

In an embodiment, the tray includes a spacer for positioning the tray within the oral cavity at a distance from the palate, and the distance is equal to or less than the focal length of the first data acquisition elements.

In an embodiment, the first data acquisition elements and the second data acquisition elements are the same type of data acquisition element.

In an embodiment, the first data acquisition elements are digital cameras, optical scanners, optical cameras, proximity sensors, or combinations thereof.

In an embodiment, the first data acquisition elements are distributed over a portion of the arch facing surface.

In an embodiment, the second data acquisition elements are distributed over a portion of the sidewall edge surface.

In an embodiment, the intraoral apparatus includes third data acquisition elements coupled to an edge surface of an endwall of the tray, the endwall in an opposed and spaced-apart relationship with the sidewall, the third data acquisition elements for acquiring third data usable for generating third images comprising a portion of a lingual sulcus, and the third data acquisition elements are distributed over a portion of the endwall edge surface.

In an embodiment, the intraoral apparatus includes third data acquisition elements coupled to an edge surface of an endwall of the tray, the endwall in an opposed and spaced-apart relationship with the sidewall, the third data acquisition elements for acquiring third data usable for generating third images comprising a portion of a lingual sulcus, and the first data acquisition elements, second data acquisition elements and the third data acquisition elements are the same type of data acquisition element.

In an embodiment, the intraoral apparatus includes third data acquisition elements coupled to an edge surface of an endwall of the tray, the endwall in an opposed and spaced-apart relationship with the sidewall, the third data acquisition elements for acquiring third data usable for generating third images comprising a portion of a lingual sulcus, and fourth data acquisition elements coupled to a flange extending from one of the sidewall edge surface or the endwall edge surface, the fourth data acquisition elements for acquiring fourth data usable for generating fourth images comprising a portion of mobile gingival tissue, and the fourth data acquisition elements are distributed over a portion of the flange.

In an embodiment, the intraoral apparatus includes third data acquisition elements coupled to an edge surface of an endwall of the tray, the endwall in an opposed and spaced-apart relationship with the sidewall, the third data acquisition elements for acquiring third data usable for generating third images comprising a portion of a lingual sulcus, and fourth data acquisition elements coupled to a flange extending from one of the sidewall edge surface or the endwall edge surface, the fourth data acquisition elements for acquiring fourth data usable for generating fourth images comprising a portion of mobile gingival tissue, and the first data acquisition elements, second data acquisition elements, third data acquisition elements and fourth data acquisition elements are the same type of data acquisition element.

In an embodiment, the intraoral apparatus includes fourth data acquisition elements coupled to a flange extending from the sidewall edge surface, the fourth data acquisition elements for acquiring fourth data usable for generating fourth images comprising a portion of mobile gingival tissue, and the fourth data acquisition elements are distributed over a portion of the flange.

In an embodiment, the intraoral apparatus includes fourth data acquisition elements coupled to a flange extending from the sidewall edge surface, the fourth data acquisition elements for acquiring fourth data usable for generating fourth images comprising a portion of mobile gingival tissue, and the first data acquisition elements, second data acquisition elements, and fourth data acquisition elements are the same type of data acquisition element.

In a further aspect, the present disclosure provides a method including acquiring first data using first data acquisition elements coupled to an arch-facing surface of a tray, the tray for positioning within an oral cavity to receive a dental arch, the first data usable for generating first images comprising a portion of the dental arch, and acquiring second data using second data acquisition elements coupled to an edge surface of a sidewall of the tray, the second data usable for generating second images comprising a portion of a facial sulcus. The first images and the second images are combinable for determining a facial sulcus depth.

In an embodiment, a portion of the first images comprise a portion of the palate and the portion of first images is combinable for determining a location of a vibrating line.

In an embodiment, the method includes acquiring third data using third data acquisition elements coupled to an edge surface of an endwall of the tray, the endwall in an opposed and spaced-apart relationship with the sidewall, the third data usable for generating third images comprising a portion of a lingual sulcus. The first images and the third images are combinable for determining a lingual sulcus depth.

In an embodiment, the method includes acquiring fourth data using fourth data acquisition elements coupled to a lingual flange extending from the endwall edge surface, the fourth data usable for generating fourth images comprising a portion of lingual mobile gingival tissue.

In an embodiment, the oral cavity is stimulated during acquisition of the first data and the second data.

In an embodiment, the oral cavity is confirmed to be at a rest position during acquisition of the first data and the second data.

In an embodiment, the oral cavity is confirmed to be at a rest position during acquisition of the first data and the second data by application of transcutaneous electrical nerve stimulation to oral cavity muscles.

In an embodiment, the method includes acquiring fourth data using fourth data acquisition elements coupled to a facial flange extending from the sidewall edge surface, the fourth data usable for generating fourth images comprising a portion of facial mobile gingival tissue.

In an embodiment, the method includes acquiring the first data simultaneously with the second data.

In an embodiment, the method includes generating the first images and the second images and producing a three-dimensional model of the dental arch and the facial sulcus from the first images and the second images, the model useable for determining the facial sulcus depth.

In an embodiment, a portion of the first images comprise a portion of the palate and the portion of first images is combinable for determining a location of a vibrating line, and the method includes generating the first images and the second images and producing a three-dimensional model of the dental arch and the facial sulcus from the first images and the second images, the model useable for determining the facial sulcus depth and the location of the vibrating line.

In an embodiment, the method includes acquiring third data using third data acquisition elements coupled to an edge surface of an endwall of the tray, the endwall in an opposed and spaced-apart relationship with the sidewall, the third data usable for generating third images comprising a portion of a lingual sulcus. The first images and the third images are combinable for determining a lingual sulcus depth. The method also includes generating the first images, the second images, and the third images and producing a three-dimensional model of the dental arch, the facial sulcus, and the lingual sulcus, the model useable for determining the facial sulcus depth and the lingual sulcus depth.

In an embodiment, the method includes acquiring fourth data using fourth data acquisition elements coupled to a lingual flange extending from the endwall edge surface, the fourth data usable for generating fourth images comprising a portion of lingual mobile gingival tissue. The method also includes generating the first images, the second images, the third images, and the fourth images and producing a three-dimensional model of the dental arch, the facial sulcus, the lingual sulcus, and the lingual mobile gingival tissue, the model useable for determining the facial sulcus depth and the lingual sulcus depth.

In an embodiment, the method includes generating the first images, the second images, and the fourth images and producing a three-dimensional model of the dental arch, the facial sulcus, and the facial mobile gingival tissue, the model useable for determining the facial sulcus depth.

In an embodiment, the method includes acquiring third data using third data acquisition elements coupled to an edge surface of an endwall of the tray, the endwall in an opposed and spaced-apart relationship with the sidewall, the third data usable for generating third images comprising a portion of a lingual sulcus, and the third data is stored in a third memory of the third data acquisition elements.

In an embodiment, the method includes acquiring third data using third data acquisition elements coupled to an edge surface of an endwall of the tray, the endwall in an opposed and spaced-apart relationship with the sidewall, the third data usable for generating third images comprising a portion of a lingual sulcus, and the third data acquisition elements are in communication with an image generating device.

In an embodiment, the method includes acquiring third data using third data acquisition elements coupled to an edge surface of an endwall of the tray, the endwall in an opposed and spaced-apart relationship with the sidewall, the third data usable for generating third images comprising a portion of a lingual sulcus, and acquiring fourth data using fourth data acquisition elements coupled to a flange extending from at least one of the sidewall edge surface or the endwall edge surface, the fourth data usable for generating fourth images comprising a portion of mobile gingival tissue, and the fourth data is stored in a fourth memory of the fourth data acquisition elements.

In an embodiment, the method includes acquiring third data using third data acquisition elements coupled to an edge surface of an endwall of the tray, the endwall in an opposed and spaced-apart relationship with the sidewall, the third data usable for generating third images comprising a portion of a second sulcus, and acquiring fourth data using fourth data acquisition elements coupled to a flange extending from at least one of the sidewall edge surface or the endwall edge surface, the fourth data usable for generating fourth images comprising a portion of mobile gingival tissue, and the fourth data acquisition elements are in communication with an image generating device.

In an embodiment, the method includes acquiring fourth data using fourth data acquisition elements coupled to a flange extending from the sidewall edge surface, the fourth data usable for generating fourth images comprising a portion of mobile gingival tissue, and the fourth data is stored in a fourth memory of the fourth data acquisition elements.

In an embodiment, the method includes acquiring fourth data using fourth data acquisition elements coupled to a flange extending from the sidewall edge surface, the fourth data usable for generating fourth images comprising a portion of mobile gingival tissue, and the fourth data acquisition elements are in communication with an image generating device.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures in which like reference numerals refer to like elements.

FIG. 1 is a perspective view of an intraoral apparatus in accordance with an embodiment of the present disclosure;

FIG. 2 is a schematic plan view of the intraoral apparatus of FIG. 1 in communication with an image generating apparatus;

FIG. 3 is a perspective view of an intraoral apparatus including an endwall in accordance with another embodiment;

FIG. 4 is a plan view of the intraoral apparatus of FIG. 3;

FIG. 5. is a perspective view of an intraoral apparatus including a flange in accordance with another embodiment;

FIG. 6 is a cross-sectional elevation view of an intraoral apparatus including a spacer in accordance with another embodiment in an individual's intraoral cavity;

FIG. 7 is a perspective view of an intraoral apparatus including headgear in accordance with an embodiment of the present disclosure;

FIG. 8 is a perspective view of an intraoral apparatus including a plurality of light-emitting elements in accordance with an embodiment of the present disclosure;

FIG. 9 is a perspective view of an intraoral apparatus including a plurality of projectors in accordance with an embodiment of the present disclosure;

FIG. 10 is an elevation view of the intraoral apparatuses of FIGS. 1 and 3 positioned in an individual's intraoral cavity;

FIG. 11 is a cross-sectional elevation view of the intraoral apparatus of FIG. 1 in an individual's intraoral cavity;

FIG. 12 is a cross-sectional elevation view of the intraoral apparatus of FIG. 5 in an individual's intraoral cavity; and

FIG. 13 is a flow-chart illustrating a method in accordance with an embodiment the present disclosure.

### DETAILED DESCRIPTION

Generally, the present disclosure provides an apparatus and method for acquiring data usable for generating an image of intraoral features of an individual, particularly intraoral features such as a sulcus, a dental arch, and/or a palate. A dental arch is a ridge of tissue including an individual's gums and, if present, teeth. Normally, an individual has a maxillary dental arch (on their upper jaw) and a mandibular dental arch (on their lower jaw). Sulci are furrows at the base of each arch. The maxillary arch has a facial sulcus (between the cheek and the arch), while the mandibular arch has a facial sulcus and a lingual sulcus (between the tongue and the arch). Multiple images of the intraoral features may be used for generating a three-dimensional model of the intraoral features of the individual. The model is useable for facilitating the production of dentures for the individual.

Impression compounds are often used in the creation of a three-dimensional model of intraoral features. However, these compounds often lead to inaccuracy of the resulting impression due to the properties of the compound itself. Impression compounds are generally not capable of capturing tissue undercuts or determining sulcus depth. Furthermore, additional inaccuracy may result if the patient moves their jaw during formation of the impression.

The shortcomings of impression compounds may be mitigated by digitally imaging the intraoral features. Digital imaging apparatuses currently available in the art generally relate to imaging teeth, or the interfaces between teeth and gums. Wand-style optical imaging devices are generally not well-suited to acquiring data for imaging large edentulous spans, for example an arch wherein more than two or three adjacent teeth are missing. Track mounted intraoral apparatus are not commercially available and are unable to acquire data for imaging the sulci at the base of a dental arch. Thus, existing digital imaging apparatuses do not provide a method for imaging a sulcus or determining sulcus depth. Acquiring data for generating an image of a sulcus is useful in producing an accurate three-dimensional model of a dental arch and surrounding tissue. The three-dimensional model may be useful in making a denture which extends into the sulcus or sulci to an appropriate extent, which facilitates maximizing comfort of the individual while using the denture. In particular, the Applicant has discovered that use of data acquisition elements distributed on both arch-facing surfaces and sulcus-facing surfaces of a dental tray provides a means for imaging an entire dental arch and associated sulcus/sulci at a point in time. In addition, the tray may remain stationary within an individual's oral cavity while imaging the entire dental arch and sulcus/sulci.

When a denturist is making a denture for an individual, the denturist may use the information obtained from the intraoral apparatus disclosed herein about the shape of the individual's intraoral features, including the individual's dental arches, sulci, and/or palate, as reference points for the denture. A three-dimensional model of the intraoral features is useful for preparing dentures, particularly a three-dimensional model that can clearly delineate the sulcus depth of an individual. A digital three-dimensional model has the benefit of being easily manipulated and supporting modeling of different dentition patterns that may be used in the denture.

The mucosa of the dental arches and of the palate are keratinized and firm, and are bound to underlying bone, making them a denture loading zone (i.e. suitable for supporting a denture). In contrast, the mucosa of the cheeks and floor of the mouth are non-keratinized and freely moveable. The keratinized and non-keratinized mucosa meet at boundaries, some of which are called “mucogingival junctions”. There are three mucogingival junctions: the facial sulcus of the maxillary arch, the facial sulcus of the mandibular arch, and the lingual sulcus of the mandibular arch. The depth of the sulci relative to the respective arches is not static and is determined in part by muscle activity. For example, the sulci have a greater depth when an individual's oral cavity muscles (for example the muscles controlling the mandible, tongue, and lips) are at rest (and the oral cavity is at a rest position), as compared to when the individual is moving their mandible, tongue, or lips. Dentures prepared for an individual should, when placed on the denture loading zone, extend into the individual's sulci when the sulci are at their shallowest depth. The sulci will be at their shallowest depth at some point during muscle activity as described above. If a denture is prepared for the sulcus depth at the rest position, the denture will be over-extended during oral muscle activity, resulting in irritation of intraoral tissues and eventual dislodgment of the denture. If a denture is prepared with a sulcus depth that is too shallow, such that it does not extend into the sulcus at a depth about equivalent to the shallowest sulcus depth, then the denture loading zone is not adequately utilized. An under-extended denture results in the forces of biting and chewing being spread over a smaller area and increased pressure on the tissues on which the denture is loaded. In addition, food and other debris are more likely to work their way under the denture if the sulcus depth is too shallow.

The intraoral apparatus provided herein can be used to acquire data during stimulation of the oral cavity muscles, for example while the individual moves their mandible, tongue, or lips. While moving their mandible, tongue, or lips, the oral cavity muscles will be tensed or relaxed to varying degrees in different positions. The intraoral apparatus can also be used to acquire data while the oral cavity muscles are at rest (i.e. while the oral cavity is at a rest position). For example, transcutaneous electrical nerve stimulation (TENS) may be applied to the individual to ensure that the oral cavity muscles are stimulated at the moment of image capture. The data is usable for imaging the intraoral features and determining depth of sulci under various types and degrees of muscle activity. Data acquired during movement of the oral cavity, at the rest position, or both, facilitates making a denture to fit the individual with an appropriate sulcus depth.

The tissue of the maxillary arch is continuous with the tissue of the palate, which is bound to the palatal bones. Because the palate is devoid of freely moveable non-keratinized alveolar mucosa, there is no mucogingival junction on the palatal side of the maxillary arch. A posterior border between the palate and non-keratinized tissue is called the “vibrating line”. The vibrating line intersects the maxillary facial mucogingival junction posterior to the maxillary arch at the hammular notch. The vibrating line is mobile during muscle activity, and if a denture extends posterior to the vibrating line during muscle activity, the individual may experience discomfort during jaw function, instability of the denture, or inappropriate triggering of gag reflexes during jaw function. Thus, in addition to extending into the facial maxillary sulcus to an appropriate depth, a maxillary denture may also have a posterior border that rests on the palate when the vibrating line is at its most anterior position.

Intraoral Apparatus

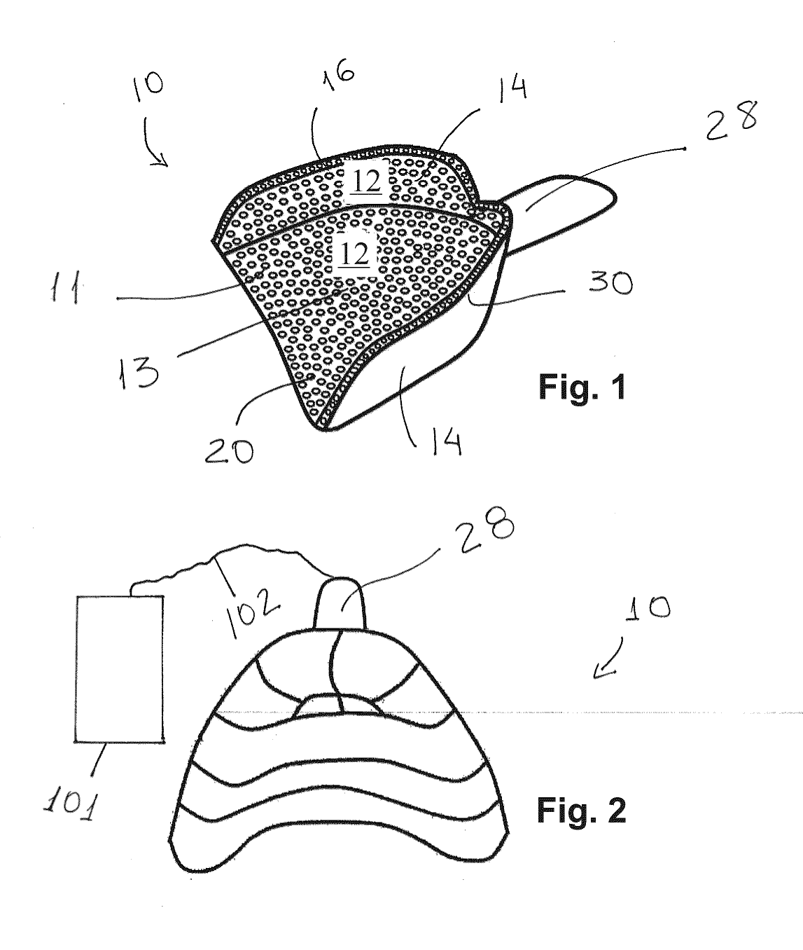

Referring to FIGS. 1 and 2, an intraoral apparatus 10 includes first data acquisition elements 20 and second data acquisition elements 30 coupled to a tray 11. A sidewall 14 extends from a base 13 of the tray 11 and around a first portion of a perimeter of the base 13. A surface of the base 13 and a surface of the sidewall 14 together define an arch-facing surface 12. First data acquisition elements 20 are coupled to the arch-facing surface 12. Second data acquisition elements 30 are coupled to an edge surface 16 of the side wall 14. The edge surface 16 of the side wall 14 is a sulcus-facing surface. The apparatus 10 may also include a handle 28 extending from the tray 11 to facilitate handling and/or positioning of the tray 11 within the oral cavity.

It will be understood that the data acquisition elements 20, 30 may be any suitable device that can acquire data for preparing two- or three-dimensional images. For example, the data acquisition elements 20, 30 may be digital cameras, optical scanners, optical cameras, proximity sensors, sensors which detect wavelengths greater than or less than the wavelengths of the visible spectrum, or combinations thereof. One example of a suitable optical camera is the NanEye camera, produced by Awaiba. The NanEye camera has dimensions of approximately 1 mm×1 mm×1.5 mm (1.5 mm being the height), and a focal length of between about 3 mm and about 5 mm. Another example of a suitable data acquisition element 20, 30 is a light-field camera (sometimes referred to as a “plenotopic camera”). The commercially-available light-field camera by Pelican Imaging may be suitable for adaptation to use as the data acquisition elements 20, 30 (see http://www.pelicanimaging.com/). Another example of a suitable data acquisition element 20, 30 is a multi-aperture sensor that can acquire data related to depth of field as well as data for preparing an image (for example, see the publication at http://isl.stanford.edu/groups/elqamal/abbas publications/C106.pdf). Another example of suitable data acquisition elements 20, 30 is found in a series of cameras produced by Medigus, which are 5 mm long or tall. The Medigus cameras have an outer diameter of 1.2, 1.8, and 3.0 mm. Another example of suitable data acquisition elements 20, 30 is a planar Fourier capture array.

In an embodiment, the first data acquisition elements 20 and the second data acquisition elements 30 may each be the same type of data acquisition element, or may comprise more than one type of data acquisition element. In an embodiment, the data acquisition elements, for example the first data acquisition elements 20 and/or the second data acquisition elements 30, may be fixed to the intraoral apparatus 10. Alternatively, the data acquisition elements 20, 30 may be removable from the intraoral apparatus 10, allowing the intraoral apparatus 10 to be heat-sterilized without the data acquisition elements 20, 30 also being heat-sterilized. The attachment points for the data acquisition elements 20, 30 may be for example apertures in which the data acquisition elements 20, 30 can be seated. In one embodiment, the data acquisition elements 20, 30 may be intended for a single use. Alternatively, the data acquisition elements 20, 30 may be intended for multiple uses, and that the intraoral apparatus may be sterilized between uses. Following sterilization, the intraoral apparatus may be placed a disposable plastic sheath, as used in most dental imaging.

In an embodiment, the first and second data acquisition elements 20, 30 are in communication with an image generating apparatus 101 via wiring 102. The image generating apparatus 101 may be any image generating apparatus capable of stitching together adjacent images based on landmarks, for example a computer or printer; such image generating apparatuses are known in the art and will not be described further. The communication may for example be through a wired or a wireless connection (exemplified by wiring 102 in FIG. 2). The image generating apparatus 101 includes a processor for executing image generating software that may be stored in a memory of the image generating apparatus 101. Software for stitching multiple images together to prepare a three-dimensional model may also be stored in the memory of the image generating apparatus 101 and executed by the processor. One example of applicable software is 3DSOM Pro.

In another embodiment, some or all of the data acquisition elements 20, 30 may be in real-time communication with the image generating apparatus 101. Alternatively, data corresponding to multiple images may be communicated in a single data transfer operation following a data acquisition session with an individual.

In one embodiment, the tray 11 may be sized to accommodate a young child's dental arch, or an adult's dental arch. It will be understood that the size of the tray 11, the particular data acquisition elements 20, 30 used, and the position of the data acquisition elements 20, 30 on the arch-facing surface 12 and the edge surface 16 will each be selected to image the intraoral features, including the arches, sulci, and associated tissue undercuts, for the intended size of intraoral features (for example child or adult). For example, there is commonly an undercut in the mylohyoid and distomylohyoid region of the mandibular arch, and acquisition of data from the undercut may be facilitated by selecting an appropriate height for the sidewall 14. In addition, imaging of the hammular notch may be accomplished by an appropriate degree of extension of the tray 11 posterior to the individual's arches. In one embodiment, to accommodate different individuals having a different sized oral cavity, the tray may be constructed from a deformable material. In another embodiment, a portion of the tray may be made from one or more pairs of rigid segments, with each pair of rigid segments joined by an articulatable coupling, for example a hinge or ball joint. It will be understood that methods for determining tray dimensions are well known in the art and will not be discussed further here.

The data acquisition elements are distributed over their corresponding surfaces as detailed below, so as to facilitate the capture of overlapping fields of view of the relevant intraoral features, for example the dental arch, sulcus/sulci, and/or palate. These overlapping images can be combined to accurately map the intraoral features of an individual's intraoral cavity. It will be understood that an appropriate spacing of data acquisition elements 20, 30 is selected based on the particular data acquisition elements 20, 30 used. For example, when the first data acquisition elements 20 and the second data acquisition elements 30 are approximately 1 mm×1 mm×1.5 mm (1.5 mm being the height), the first data acquisition elements 20 may be distributed over a portion of the arch-facing surface 12 with a spacing of between about 1 mm and about 2 mm between neighboring first data acquisition elements 20. Alternatively, the first data acquisition elements 20 may be distributed over a portion of the arch-facing surface 12 at a density of between about 50 and about 100 first data acquisition elements 20 per cm². The second data acquisition elements 30 may be distributed over a portion of the edge surface 16 with a spacing of between about 1 and about 2 mm between neighboring second data acquisition elements 30. Alternatively, the second data acquisition elements 30 may be distributed over a portion of the edge surface 16 at a density of between about 50 and about 100 second data acquisition elements 30 per cm².

In an embodiment, a portion of the arch-facing surface 12 may be contoured to conform to the shape of the palate to facilitate acquiring data by the first data acquisition elements 20. Contouring may facilitate conforming to the shape of the palate where, for example, the individual has a mid-palatal torus or other protuberance from their palate.

In an embodiment, the first data acquisition elements 20 may be synchronized to simultaneously acquire the data. In an embodiment, the second data acquisition elements 30 may be synchronized to simultaneously acquire data. In an embodiment, the first data acquisition elements 20 and the second data acquisition elements 30 may be collectively synchronized to simultaneously acquire data.

In an embodiment, the data acquisition elements may comprise a heat-resistant coating. The heat-resistant coating protects the data acquisition elements 20, 30 from heat, for example, as encountered while heat-sterilizing the intraoral apparatus 10 with an autoclave. Alternatively, the entirety of the intraoral apparatus 10 may comprise a heat-resistant coating. It will be understood that heat-resistant coatings are well known in the art and will not be discussed further herein.

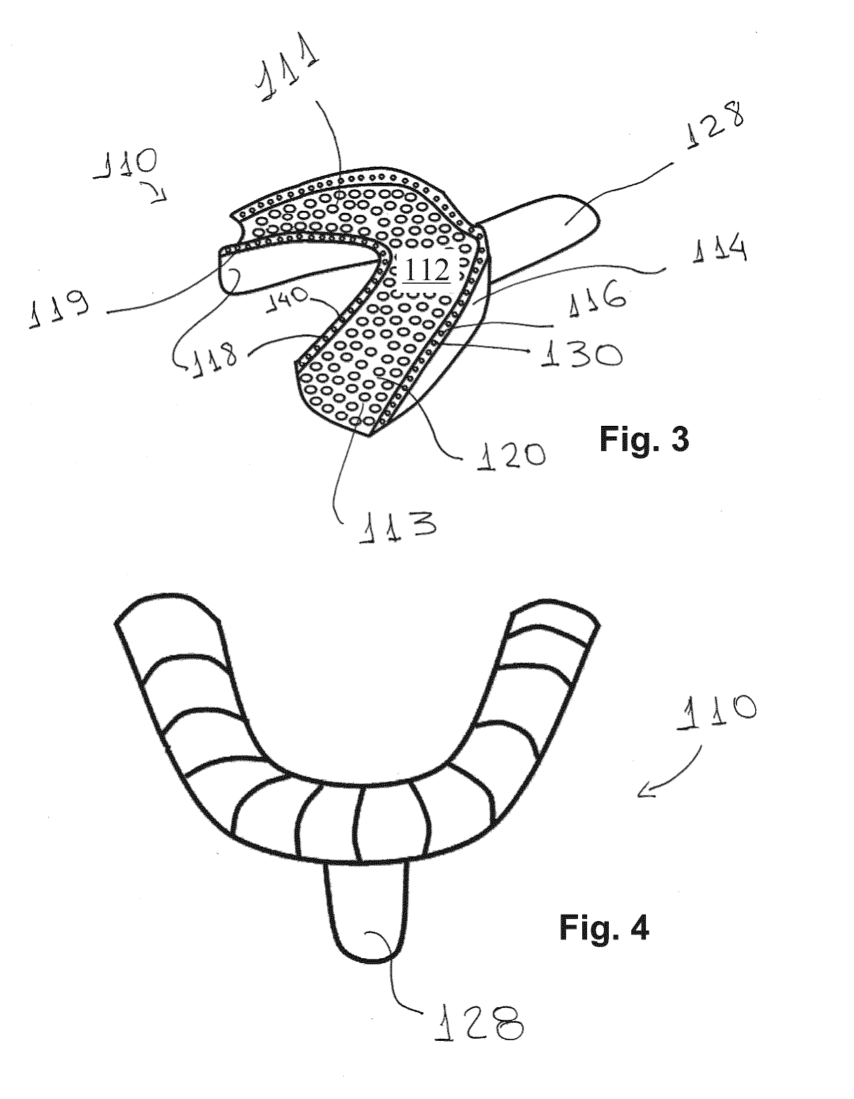

FIGS. 3 and 4 respectively show perspective and plan views of another embodiment of an intraoral apparatus 110. An endwall 118 extends from the base 113 and around a second portion of the perimeter of the base 113. The endwall 118 is spaced apart and opposed from the sidewall 114. Third data acquisition elements 140 are coupled to an edge surface 119 of the endwall 118. The edge surface 119 of endwall 118 is another sulcus-facing surface. The first data acquisition elements 120, second data acquisition elements 130, and third data acquisition elements 140 may each be any suitable device that can acquire data for preparing a two- or three-dimensional image, as discussed above in relation to the data acquisition elements 20, 30 of the intraoral apparatus 10. In an embodiment, the first data acquisition elements 120, the second data acquisition elements 130, and/or the third data acquisition elements 140 may each be the same type of data acquisition element, or may comprise more than one type of data acquisition element. It will be understood that an appropriate spacing of data acquisition elements 140 is selected based on the particular data acquisition elements 140 used. For example, when the third data acquisition elements 140 are approximately 1 mm×1 mm×0.5 mm (0.5 mm being the height), the third data acquisition elements 140 may be distributed over a portion of the edge surface 119 with a spacing of between about 1 and about 2 mm between neighboring third data acquisition elements 140. Alternatively, the third data acquisition elements 140 may be placed over a portion of the edge surface 119 at a density of between about 50 and about 100 third data acquisition elements 140 per cm². In an embodiment, the third data acquisition elements 140 may be fixed to the intraoral apparatus 110. Alternatively, the third data acquisition elements 140 may be removable from intraoral apparatus 110.

In an embodiment, the third data acquisition elements 140 may be synchronized to simultaneously acquire data. In an embodiment, the first data acquisition elements 120, the second data acquisition elements 130, and/or the third data acquisition elements 140 may be collectively synchronized to simultaneously acquire data.

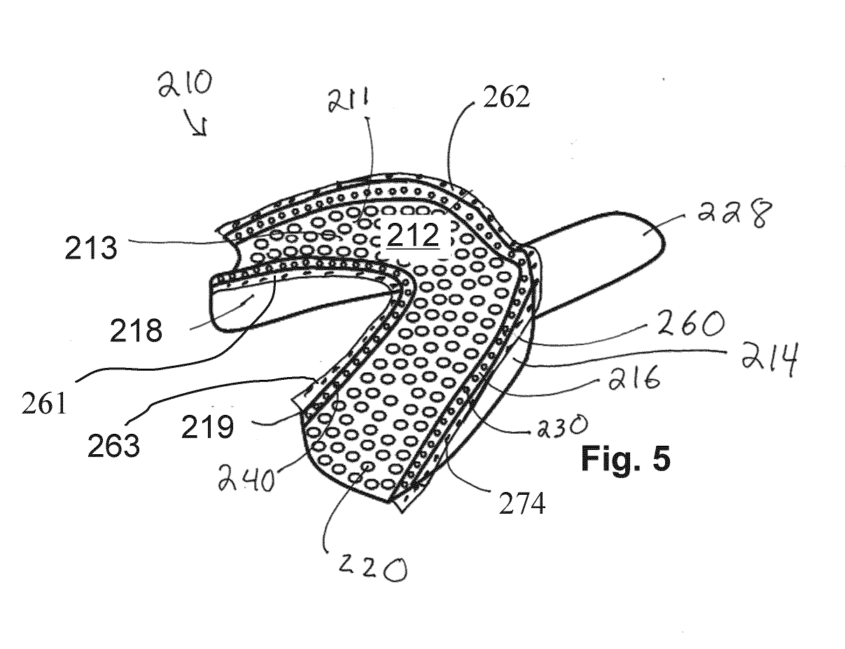

FIG. 5 shows a perspective view of another embodiment of an intraoral apparatus 210. A facial flange 260 may extend from the sidewall 214, a lingual flange 261 may extend from the endwall 218, or both. Fourth data acquisition elements 274 are coupled to a facial flange surface 262 of the facial flange 260, to a lingual flange surface 263 lingual flange 261, or both. The facial flange surface 262 may be a sulcus facing surface, a facial mobile gingival tissue facing surface (for mobile gingival tissue beyond a sulcus), or both. The lingual flange surface 263 may be a sulcus facing surface, a lingual mobile gingival tissue facing surface (for mobile gingival tissue beyond a sulcus), or both. The fourth data acquisition elements 274 are for acquiring data usable for generating an image of mobile gingival tissue, the sulci, and/or tissue undercuts near the sulci. If tissue undercuts are severe, and multiple, the designed prosthetic would require removal of material in the undercut region, to ensure a path of insertion. The path of insertion allows the denture to be fully seated on the gingival tissues. If these regions are not relieved, it may not be possible to fully seat the denture on the gingival tissues or the patient may experience significant discomfort.

The first data acquisition elements 220, second data acquisition elements 230, third data acquisition elements 240, and fourth data acquisition elements 274, may each be any suitable device that can acquire data for preparing a two-dimensional image, as discussed above in relation to the data acquisition elements 20, 30 of the intraoral apparatus 10. The first data acquisition elements 220, the second data acquisition elements 230, the third data acquisition elements 240, the fourth data acquisition elements 274, may each be the same type of data acquisition element, or may comprise more than one type of data acquisition element. It will be understood that an appropriate spacing of data acquisition elements 270 is selected based on the particular data acquisition elements 270 used. For example, when the fourth data acquisition elements 274 are approximately 1 mm×1 mm×0.5 mm (0.5 mm being the height), the fourth data acquisition elements 274 may be distributed over portions of the flanges 260, 261 with a spacing of between about 1 and about 2 mm between neighboring fourth data acquisition elements 274. Alternatively, the fourth data acquisition elements 274 may be distributed over a portion of the facial flange 260 and the lingual flange 261 at a density of between about 50 and about 100 fourth data acquisition elements 274 per cm². In an embodiment, the fourth data acquisition elements 274 may be fixed to the intraoral apparatus 210 (for example as discussed above in relation to the intraoral apparatus 10). Alternatively, the fourth data acquisition elements 274 may be removable from intraoral apparatus 210 (for example as discussed above in relation to the intraoral apparatus 10).

In an embodiment, the fourth data acquisition elements 274 may be synchronized to simultaneously acquire data. In an embodiment, the first data acquisition elements 220, the second data acquisition elements 230, the third data acquisition elements 240, the fourth data acquisition elements 274, may be collectively synchronized to simultaneously acquire data.

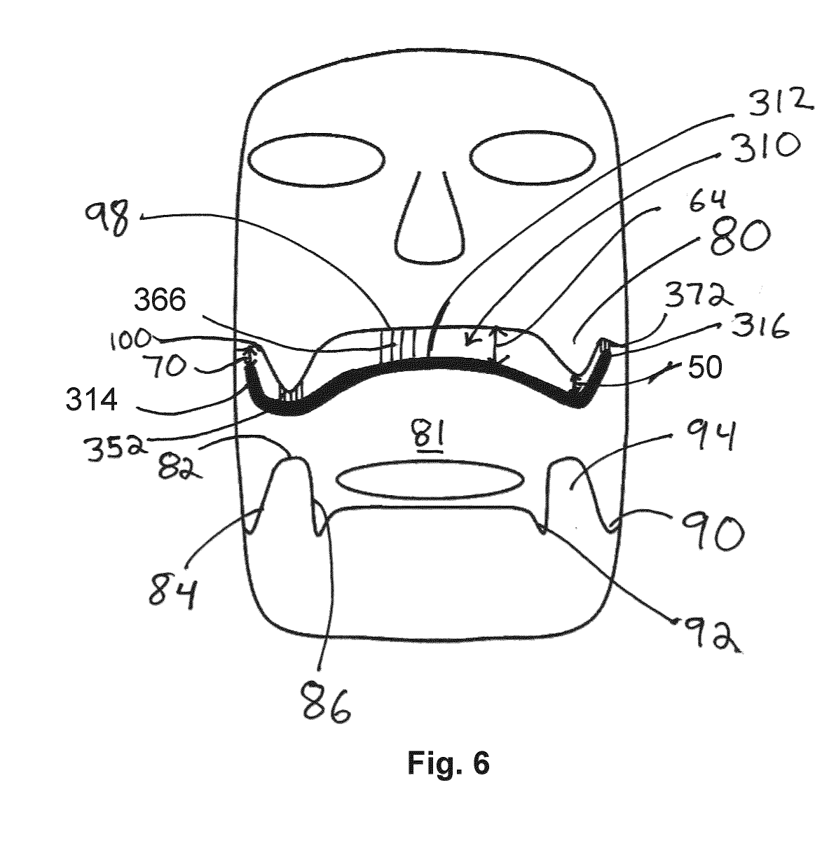

FIG. 6 is a cross-sectional elevation view of an intraoral apparatus 310 in an individual's intraoral cavity 81. The intraoral apparatus 310 is separated from a maxillary dental arch 80 by a first distance 50, from a palate 98 by a second distance 64, and from a maxillary facial sulcus 100 by a third distance 70. Spacers facilitate positioning the intraoral apparatus 310 at the distances 50, 64, and 70 from intraoral features, particularly from the maxillary dental arch 80, the palate 98, and the maxillary facial sulcus 100, to facilitate imaging of the corresponding intraoral features. A first spacer 352 facilitates positioning the intraoral apparatus 310 at the distance 50 from the maxillary dental arch 80 to facilitate imaging of the maxillary dental arch 80. A second spacer 364 facilitates positioning the intraoral apparatus 310 at the distances 64 from the palate 98 to facilitate imaging of the palate 98. A third spacer 372 facilitates positioning the intraoral apparatus 310 at the distance 70 from the maxillary facial sulcus 100, to facilitate imaging of the maxillary facial sulcus 100.

The distances 50, 64, and 70 each provide an air gap between the intraoral apparatus 310 and the corresponding intraoral features. In one embodiment, the distances 50, 64, and 70 are each about 1 mm. Alternatively, the intraoral apparatus 10 may be positioned at distances 50, 64, and 70 of between about 1 mm and about 5 mm. It will be understood that the spacers 352, 366, and 372 will separate the data acquisition elements 20, 30 from the intraoral features by distances of no greater than the focal length of the specific data acquisition elements being used. The spacers 352, 366, and 372 may be any suitable shape or size, and may be located at any position on the intraoral apparatus 10 suitable to facilitate positioning of the intraoral apparatus 10 at a distance from the intraoral features. For example, the spacers 352, 366, and 372 may be projections extending from a portion of the tray 311. Alternatively, the spacers may be positioned around a portion of a perimeter of one of more of the individual data acquisition elements.

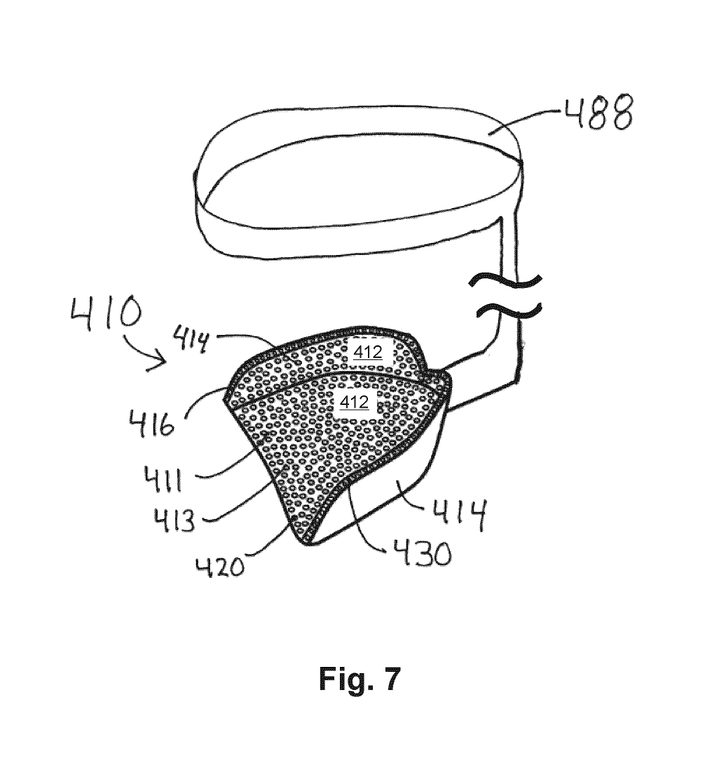

FIG. 7 is a perspective view of an intraoral apparatus 410 including headgear 488. The headgear 488 facilitates positioning of the intraoral apparatus 410 at a selected distance from the intraoral features (for example at the distance 50 from the maxillary dental arch 80, the distance 64 from the palate 98, and the distance 70 from the maxillary facial sulcus 100) to facilitate imaging of the intraoral features. The headgear 488 enables the position of the tray 411 to be fixed in the oral cavity of the individual during imaging even if the individual moves their head during operation of the intraoral apparatus 410.

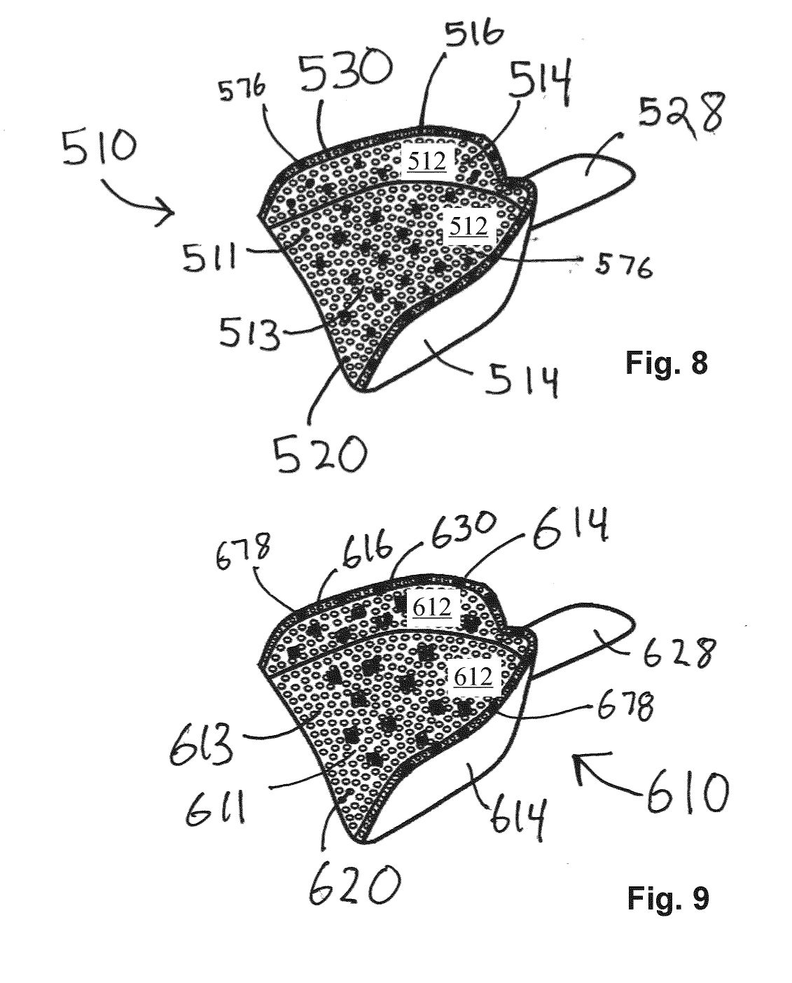

FIG. 8 is a perspective view of an intraoral apparatus 510 including a light source with a plurality of light-emitting elements 576. The light-emitting elements 576 illuminate intraoral features during acquisition of data usable for generating an image of the intraoral feature. Illumination of the intraoral features may facilitate acquisition of data, particularly where the data is being acquired by an optical camera. It will be understood that any suitable light source may be used, for example the LEDs or a fiber optic strand. The light source may for example be a plurality of light-emitting elements 576 (such as LEDs or termination points of fiber optic strands) interspersed with the data acquisition elements 520, 530. For example, a pentagon or honeycomb arrangement of one light-emitting element 576 surrounded by five or six first data acquisition elements 520 on the arch-facing surface 512. Alternatively, a linear series of second data acquisition elements 530 on the edge surface 516 may include a light-emitting element 576 at regular intervals, for example with one light-emitting element 576 regularly following every four second data acquisition elements 530.

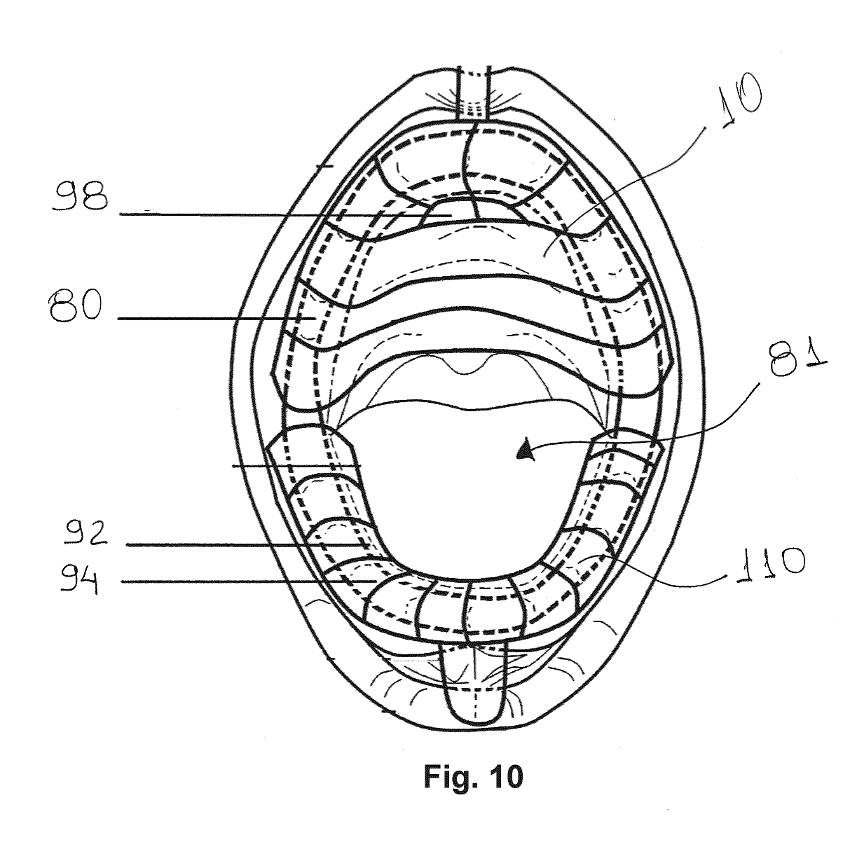

FIG. 9 is a perspective view of an intraoral apparatus 610 including a plurality of projectors 678. Each projector 678 is for projecting an orientation point onto an intraoral feature during acquisition of data usable for generating an image of the intraoral feature. This orientation point is included in the image generated and facilitates the combining of multiple overlapping images to generate a three-dimensional model. It will be understood that any suitable projector 678 may be used, for example a laser projector. One or more projectors may be regularly spaced with the data acquisition elements 620, 630. For example, the projectors 678 may be interspersed with the data acquisition elements 620, 630. For example, a pentagon or honeycomb arrangement of one projector 678 surrounded by five or six first data acquisition elements 620 on the arch-facing surface 612. Alternatively, a linear series of second data acquisition elements 630 on the edge surface 616 may include a projector 678 at regular intervals, for example with one projector 678 regularly following every four second data acquisition elements 630.

Operation

FIG. 10 shows an elevation view of the intraoral apparatus 10 and the intraoral apparatus 110 in an oral cavity 81 of an individual. A maxillary dental arch 80 is positioned in the intraoral apparatus 10 and a mandibular dental arch 94 is positioned in the intraoral apparatus 110.

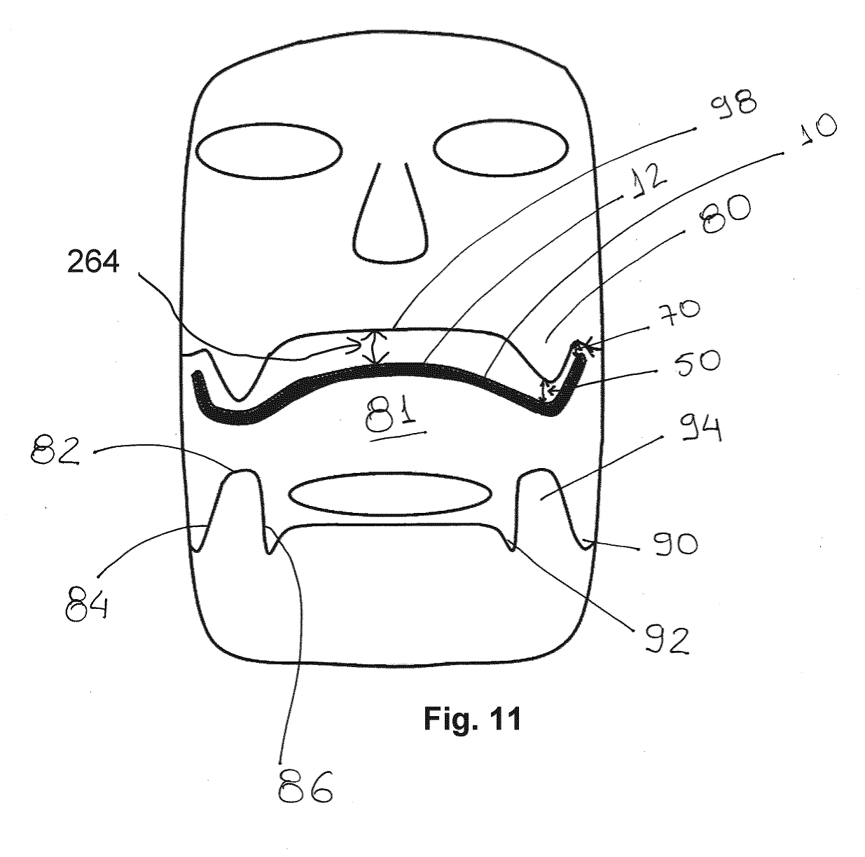

FIG. 11 shows a cross-sectional elevation view of the intraoral apparatus 10 in the intraoral cavity 81. The tray 11 receives the maxillary dental arch 80 and the arch-facing surface 12 faces the maxillary dental arch 80 at a ridge surface 83 and a facial surface 85. The arch-facing surface 12 also faces a palate 98. The edge surface 16 of the tray 11 faces a maxillary facial sulcus 100.

When the intraoral apparatus 10 is positioned in the intraoral cavity 81 with the maxillary arch 80 in the tray 11, the first data acquisition elements 20 distributed on the arch-facing surface 12 for acquiring first data usable for generating first images of a portion of the maxillary dental arch 80, the palate 98, or both. Similarly, the second data acquisition elements 30 distributed on the edge surface 16 of the sidewall 14 for acquiring second data usable for generating second images of a portion of the facial sulcus 100. The intraoral apparatus 10 is positioned within the oral cavity 81 at the first distance 50 from the maxillary dental arch 80 to facilitate imaging. Similarly, a portion of the arch-facing surface 12 may be positioned within the oral cavity 81 at the second distance 64 from the palate 98 to facilitate imaging. The first distance 50 and the second distance 70 may each vary as between the first data acquisition elements 20 at different points from the arch-facing surface 12. It will be understood that the first distance 50 and the second distance 70 at any given point on the arch-facing surface 12 will be selected with reference to the focal length of the first data acquisition elements 20 at that point. Similarly, the edge surface 16 is located at a distance 70 from the facial sulcus 100. The distance 70 may vary as between second data acquisition elements 30 at different points on the edge surface 16. It will be understood that the distance 70 at any given point on the edge surface 16 will be selected with reference to the focal length of the second data acquisition elements 30 at that point. The first images and the second images are combinable for determining a shallowest sulcus depth of the individual.

The intraoral apparatus 10 facilitates imaging of the maxillary arch 80, palate 98, and/or the facial sulcus 100 from a single position within the intraoral cavity 81 such that the first data acquisition elements 20 and the second data acquisition elements 30 respectively acquire the first data and the second data from a single position within the intraoral cavity 81. Preferably, the intraoral apparatus 10 acquires the first data and the second data during stimulation of the individual's oral cavity muscles, for example by movement of their tongue, lips, or jaw, either by the individual or by another person manipulating the individual's tongue, lips, or jaw. Imaging while stimulating the oral cavity muscles enables the shallowest depth of the sulcus to be determined, for example the shallowest depth of the facial sulcus 100. The vibrating line can be located by observing the individual under different conditions of muscle stimulation (for example when the individual says “ahhh” during data acquisition). Multiple images may be acquired under such stimulation and the images compared to identify the vibrating line. The intraoral apparatus 10 may also acquire the first data and the second data while the intraoral cavity 81 is at the rest position. TENS may be applied to the individual to ensure that the oral cavity muscles are stimulated and that the intraoral cavity 81 is in the stimulated position.

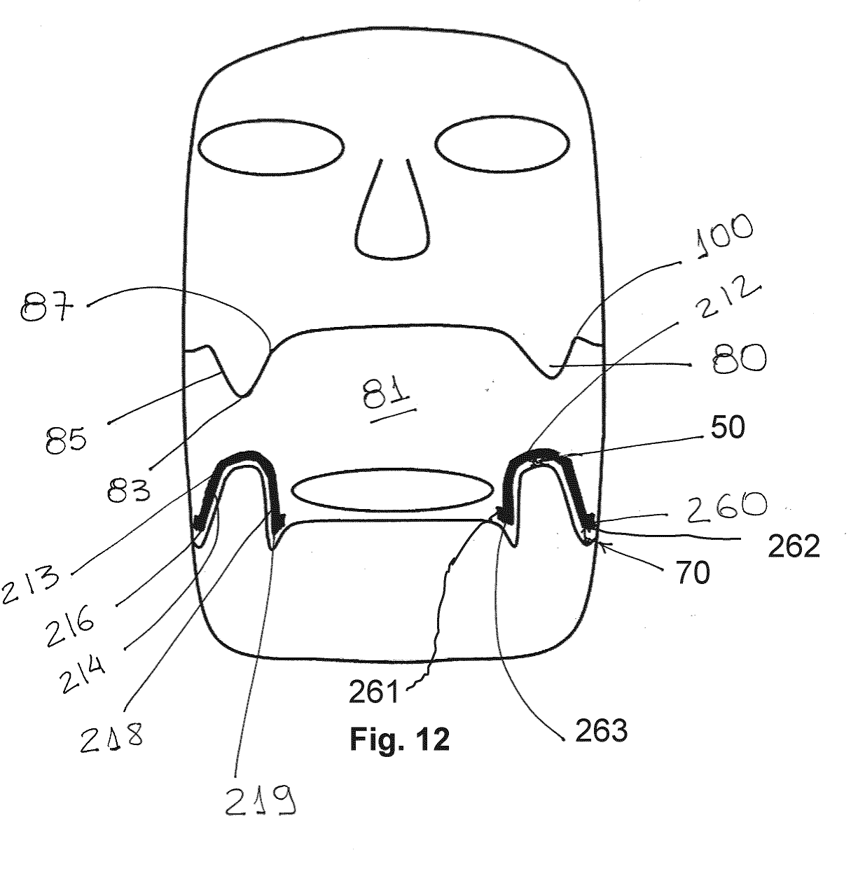

FIG. 12 shows a cross-sectional elevation view of the intraoral apparatus 210 in the intraoral cavity 81. The tray 211 receives the mandibular dental arch 94 and the arch-facing surface 212 faces the mandibular dental arch 94 at a ridge surface 82, a facial surface 84, and a lingual surface 86. The edge surface 216 of the sidewall 214 faces a mandibular facial sulcus 90. The edge surface 219 of the endwall 218 faces a lingual sulcus 92. The facial flange 260 faces facial mobile gingival tissue. The lingual flange 261 faces lingual mobile gingival tissue.

When the intraoral apparatus 210 is positioned in the intraoral cavity 81 with the mandibular dental arch 94 in the tray 211, the first data acquisition elements 220 distributed on the arch-facing surface 212 acquire first data usable for generating first images of a portion of the mandibular dental arch 94. Similarly, the second and third data acquisition elements 230, 240 are respectively distributed on the edge surfaces 216, 219 of the sidewall 214 and endwall 218. The second and third data acquisition elements 230, 240 respectively acquire second data and third data. The second data is usable for generating second images of a portion of the mandibular facial sulcus 90. The third data is usable for generating images of a portion of the lingual sulcus 92. In an embodiment, fourth data acquisition elements 274 distributed on the facial flange surface 262 of the facial flange 260 acquire fourth data usable for generating fourth images of a portion of facial mobile gingival tissue. In an embodiment, fourth data acquisition elements 274 distributed on the lingual flange surface 263 of the lingual flange 261 acquire fourth data usable for generating fourth images of a portion of lingual mobile gingival tissue.

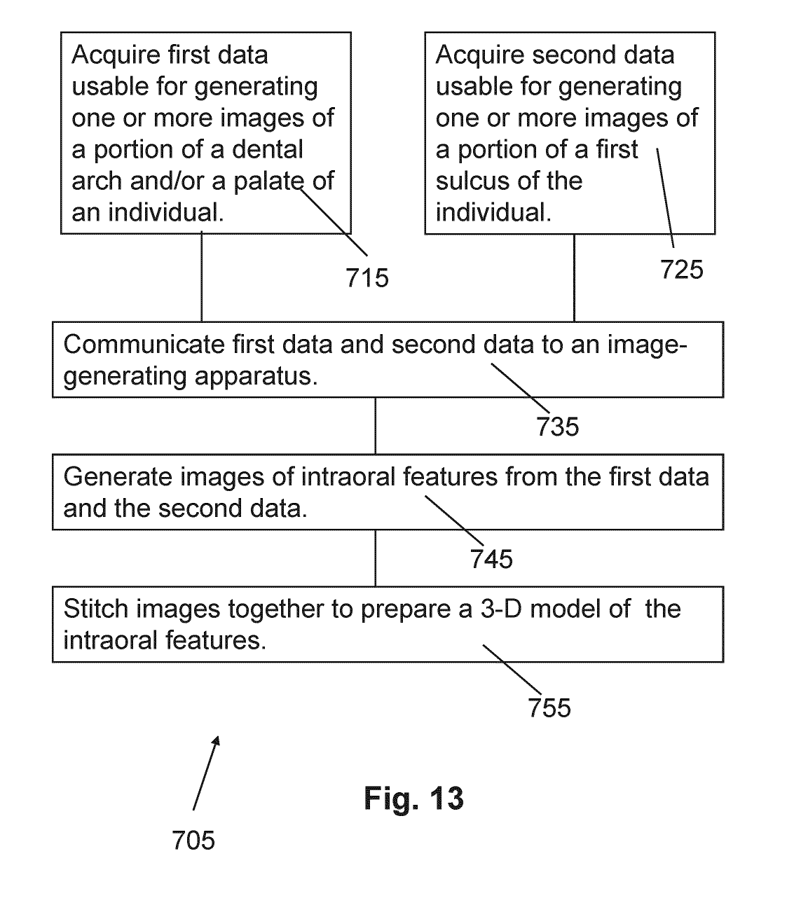

FIG. 13 is a block diagram of a method 705 according to an embodiment of the present disclosure. Using an intraoral apparatus as described herein (for example intraoral apparatus 10, intraoral apparatus 110, intraoral apparatus 210, intraoral apparatus 310, intraoral apparatus 410, intraoral apparatus 510, or intraoral apparatus 610), first data is acquired 715 from intraoral features of an individual, for example an arch and/or palate. Second data is acquired 725 from intraoral features of an individual, for example a sulcus. Third data and fourth data as described above may also be acquired. The first data and the second data are communicated 735 to an image generating apparatus, for example through wired or wireless communication as described above. A series of images of the intraoral features are generated 745 from the first data and the second data. The images are then stitched together 755 to prepare a three-dimensional model of the intraoral features of the individual. The first data and the second data may be acquired 715, 725 while the individual is at a variety of degrees of stimulation of their facial muscles as described above, to facilitate determination of variance in sulcus depth and to locate the vibrating line. The first data and the second data may be acquired 715, 725 simultaneously.

Details

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

### Examples Only

The above-described embodiments are intended to be examples only. Alterations, modifications and variations can be effected to the particular embodiments by those of skill in the art without departing from the scope, which is defined solely by the claims appended hereto.

What is claimed is:

1. An intraoral apparatus comprising:
a tray for positioning within an oral cavity to receive a dental arch;
first data acquisition elements coupled to an arch-facing surface of the tray, the first data acquisition elements for acquiring first data usable for generating first images comprising a portion of the dental arch; and
second data acquisition elements coupled to an edge surface of a sidewall of the tray, the second data acquisition elements for acquiring second data usable for generating second images comprising a portion of a facial sulcus;
wherein the first images and the second images are combinable for determining a facial sulcus depth.

2. The intraoral apparatus according to claim 1, wherein a portion of the arch-facing surface is contoured for conforming to the shape of a palate, a portion of the first images comprise a portion of the palate, and the portion of the first images is combinable for determining the location of a vibrating line.

3. The intraoral apparatus according to claim 1, comprising third data acquisition elements coupled to an edge surface of an endwall of the tray, the endwall in an opposed and spaced-apart relationship with the sidewall, the third data acquisition elements for acquiring third data usable for generating third images comprising a portion of a lingual sulcus, wherein the first images and the third images are combinable for determining a lingual sulcus depth.

4. The intraoral apparatus according to claim 3 comprising fourth data acquisition elements coupled to a lingual flange extending from the endwall edge surface, the fourth data acquisition elements for acquiring fourth data usable for generating fourth images comprising a portion of lingual mobile gingival tissue.

5. The intraoral apparatus according to claim 1, the tray comprising a spacer for positioning the tray within the oral cavity at a distance from the dental arch.

6. The intraoral apparatus according to claim 1, comprising headgear couplable to the tray for positioning the tray within the oral cavity.

7. The intraoral apparatus according to claim 1, comprising a handle coupled to the tray for positioning the tray within the oral cavity.

8. The intraoral apparatus according to claim 1, comprising a projector coupled to the tray for projecting an orientation point onto a surface of the oral cavity.

9. The intraoral apparatus according to claim 1, comprising a light source coupled to the tray for illuminating the oral cavity.

10. The intraoral apparatus according claim 1, comprising fourth data acquisition elements coupled to a facial flange extending from the sidewall edge surface, the fourth data acquisition elements for acquiring fourth data usable for generating fourth images comprising a portion of facial mobile gingival tissue.

11. The intraoral apparatus according to claim 1, wherein the first data acquisition elements and the second data acquisition elements are synchronized for acquiring the first data simultaneously with the second data.

12. The intraoral apparatus according to claim 1, wherein the first data acquisition elements and the second data acquisition elements comprise a heat-resistant coating for protection from heat during cleaning.

13. The intraoral apparatus according to claim 1, wherein the tray comprises a portion made from a deformable material.

14. The intraoral apparatus according to claim 1, wherein the tray comprises a portion made from made from one or more pairs of rigid segments, each pair of rigid segments joined by an articulatable coupling.

15. The intraoral apparatus according to claim 1, wherein the first data acquisition elements and the second data acquisition elements are removable from the intraoral apparatus.

16. A method comprising:
acquiring first data using first data acquisition elements coupled to an arch-facing surface of a tray, the tray for positioning within an oral cavity to receive a dental arch, the first data usable for generating first images comprising a portion of the dental arch; and
acquiring second data using second data acquisition elements coupled to an edge surface of a sidewall of the tray, the second data usable for generating second images comprising a portion of a facial sulcus;
wherein the first images and the second images are combinable for determining a facial sulcus depth.

17. The method according to claim 16, wherein a portion of the first images comprise a portion of the palate and the portion of first images is combinable for determining a location of a vibrating line.

18. The method according to claim 16, comprising acquiring third data using third data acquisition elements coupled to an edge surface of an endwall of the tray, the endwall in an opposed and spaced-apart relationship with the sidewall, the third data usable for generating third images comprising a portion of a lingual sulcus, wherein the first images and the third images are combinable for determining a lingual sulcus depth.

19. The method according to claim 18, comprising acquiring fourth data using fourth data acquisition elements coupled to a lingual flange extending from the endwall edge surface, the fourth data usable for generating fourth images comprising a portion of lingual mobile gingival tissue.

20. The method according to claim 16, wherein the oral cavity is stimulated during acquisition of the first data and the second data.

21. The method according to claim 16, wherein the oral cavity is confirmed to be at a rest position during acquisition of the first data and the second data.

22. The method according to claim 21, wherein the oral cavity is confirmed to be at the rest position by application of transcutaneous electrical nerve stimulation to oral cavity muscles.

23. The method according to claim 16, comprising acquiring fourth data using fourth data acquisition elements coupled to a facial flange extending from the sidewall edge surface, the fourth data usable for generating fourth images comprising a portion of facial mobile gingival tissue.

24. The method according to claim 16 comprising acquiring the first data simultaneously with the second data.

25. The method according to claim 16, comprising
generating the first images and the second images; and
producing a three-dimensional model of the dental arch and the facial sulcus from the first images and the second images, the model useable for determining the facial sulcus depth.

26. The method according to claim 17, comprising
generating the first images and the second images; and
producing a three-dimensional model of the dental arch and the facial sulcus from the first images and the second images, the model useable for determining the facial sulcus depth and the location of the vibrating line.

27. The method according to claim 18, comprising
generating the first images, the second images, and the third images; and
producing a three-dimensional model of the dental arch, the facial sulcus, and the lingual sulcus, the model useable for determining the facial sulcus depth and the lingual sulcus depth.

28. The method according to claim 19 comprising
generating the first images, the second images, the third images, and the fourth images; and
producing a three-dimensional model of the dental arch, the facial sulcus, the lingual sulcus, and the lingual mobile gingival tissue, the model useable for determining the facial sulcus depth and the lingual sulcus depth.

29. The method according to claim 16, comprising
generating the first images, the second images, and the fourth images; and
producing a three-dimensional model of the dental arch, the facial sulcus, and the facial mobile gingival tissue, the model useable for determining the facial sulcus depth.
